(19) United States
(12) Patent Application Publication
(10) Pub. No.: US 2005/0200961 A1
(43) Pub. Date: Sep. 15, 2005

(54) Microlens and method of marking same

(76) Inventors: Michael Rosenbluh, Modi"in (IL); Yuri Kaganovskii, LeZion (IL)

Correspondence Address: Martin Moynihan;Anthony Castorina, Suite 207, 2001 Jefferson Davis Highway, Arlington, VA, 22202, US

(21) Appl. No.: 10/516,942

(22) PCT Filed: Jun. 17, 2003
(86) PCT No.: PCT/IL03/00516

§ 371 Date: Dec. 16, 2004

(30) Foreign Application Priority Data
Jun. 17, 2002 (US) 60388752

(51) Int. Cl. G02B 27/10

(52) U.S. Cl. 359/626

(57) ABSTRACT

A method of forming a microlens, comprising providing a doped glass having at least one metallic component other than copper, and locally irradiating the doped glass by a continuous wave laser beam, so as to melt a portion of the doped glass, thereby to form the microlens.

### FIELD AND BACKGROUND OF THE INVENTION

The present invention relates to micro-optical elements and, more particularly, to microlenses which are transparent to a wide spectrum of wavelengths.

Micro-optical elements are widely used in integrated optics. Many optical systems, such as imaging systems, telecommunications devices, micro-optical systems and micro-mechanical systems typically combine several optical articles and lenses for delivering the desired optical performance. As the size of the optical systems shrinks, optical engineers are increasingly turning to the smaller optical element. One such optical element is a tiny lens called a microlens, which is suited for a variety of tasks from fine tuning laser beams, to sensing an optical wavefront and to heightening image quality. Many optical systems employ one or more microlens arrays, each consists of several microlenses geometrically positioned and aligned in a manner suitable for the particular application to which the optical system is designed.

Microlenses and microlens arrays are typically used for high efficiency coupling between light and optical elements having a relatively small cross sectional area. In the field of integrated optics, where miniaturized optical circuits of high functionality are integrated on a common substrate, microlenses are used as couplers between a laser beam and an optical fiber. With the continuously increasing interest in optics, there exists a growing need in the development of complex integrated optoelectronics circuits, where microlenses and microlens arrays play a crucial role.

In the field of imaging, microlenses are used in imaging devices having an array of sensors such as charge couple device (CCD) sensors or complementary metal oxide semiconductor (CMOS) sensors. The microlens collects light from a large area and focuses it on the sensor, which typically has a relatively small aperture. The use of microlenses and microlens arrays significantly improves the light sensitivity of the imaging device.

Microlenses are also used in display devices. In a typical display device, an optical switch is activated by light from a background source, where the coverage area of the background source is substantially larger that the active area of the optical switch. The microlens is thus used for focusing the light from the background light source to the optical switch, thereby significantly increasing the light output (brightness) of the display device.

Another use of microlens arrays is in projection devices. In a typical projection device a powerful lamp generates white light, which is split into several monochrome light components (e.g., the three primary colors Red, Green and Blue) by means of special mirrors or prisms. Each monochrome light component then illuminates a separate liquid crystal display (LCD) panel, which is supplied with the image information via the modified input signal. The LCD panel is divided into many individual pixels, each of which is selectively addressed using a micro-fine grid to block the light from one pixel from influencing an adjoining pixel. To compensate light losses during the blocking process, a microlens array is positioned in front of the micro-grid. Each microlens concentrates the incoming light and directs the entire quantity of light exactly through the micro-grid, so as to ensure that the minimum possible quantity of light falls on and hence absorbed by the grid itself.

Other projection devices are based on a single LCD panel (as opposed to the several LCD panels described above). In such systems, a single LCD with integrated color filter matrix is directly illuminated by a white light source, thus leading to a very simple optical design. However, due to the absorption and spatial distribution of the color filter matrix, more than two-thirds of the luminous flux is lost through the LCD panel. To improve the efficiency of the system, a microlens array selectively directs all the light corresponding to a primary color to the pixel addressed with the corresponding video composite signal.

In recent years there has been a significant improvement in the output of light emitting diodes (LEDs). Nowadays, LEDs of unprecedented efficiency are available in high brightness levels and nearly any color. However, for applications requiring uniform illumination, supplementary optics is employed so as to shape the beam emitted by the LEDs. It is recognized that an appropriately designed arrangement of microlens arrays is a natural candidate for minimizing diffraction effects and providing a homogeneous intensity distribution in a LED based display.

An additional application in which microlens arrays play a crucial role is in the field of integral photography. Integral photography technology is a photographic technique in which the point of view of an image can be continuously moved in any direction, without the need for special doped glasses at the time of observation. A special feature of an integral photography system is that it employs a microlens array as an optical system for capturing and displaying 3-D scenes with “multiple eyes”. The microlens array pieces together an image from the element images formed by the light rays that pass through the center of each microlens. Expressed differently, integral photography is a technique for recording and reproducing light rays for each direction at each position of the microlens as a single picture element.

Microlens arrays are widely used also in wavefront sensing apparati and devices, for the purpose of determining the phase and the amplitude of a wavefront. The ability to analyze a wavefront so as to quantify its distortions is of major importance in many applications, from small scale applications, e.g., determining refractive errors in the human eye or aberrations in microscope imaging systems, through large scale applications, e.g., determining aberrations in magnifying devices, and up to astronomical scale applications were distortions, caused by interaction of light originating from a star with the earth's atmosphere, are determined.

A typical wavefront sensing device consists of a microlens array and a respective array of photodetectors. Tilt of the wavefront incident on a particular lens of the microlens array is translated into a shift in the position of the focused spot detected in the plane of the photodetectors array. The extent of any tilt of a wavefront can therefore be quantified through a suitable combination of signals from the photodetector. The above principle can be considered, to lowest order, as a determination of a first derivative of the wavefront across a complete aperture. More sophisticated wavefront sensing device are capable of determining higher order derivative. This information can be used for correcting the wavefront distortion, either optically or electro-optically, depending on the application of relevance.

Similar principles are also employed for surface characterization, where distortions of wavefront reflected from the surface are used to characterize the surface.

Yet an additional class of applications in which microlenses and microlens arrays are useful, is the class of retroreflector arrays or retroreflective sheets. A retroreflector is an optical device capable of reflecting a light ray in a direction antiparallel to its incident direction, or nearly so, such that the light ray returns to the light source or the immediate vicinity thereof.

One type of retroreflector array is constructed from a microlens array embedded in a cover layer. Behind the rear surfaces of the microlens array, separated by a spacing layer, a reflective layer, e.g., vapor-coated aluminum, is disposed such that light penetrating through, and directed by the microlenses is reflected out by the reflective layer. Each microlens of the microlens array, in combination with its reflective surface is sometimes referred to in the literature as a cat eye retroreflector element. Since both the incoming and the outgoing light rays are focused by the microlens array, each cat eye retroreflector element reflects the light in a direction which essentially has a zero angle relative to that of an incident light ray, with little or no dependence on the angle between the light ray and the reflector surface.

This advantageous property of retroreflectors has led to the widespread implementation thereof in planar array configurations which can be utilized in a variety of applications. For example, arrays of miniature retroreflector are often utilized in sheeting which are used for road signs in order to increase their visibility to motorists at night and for retroreflective safety devices used in vehicles and by other road users. Retroreflector arrays are also used with light barriers and with a beam scanning apparatus, such as the beam scanning apparatus used for generating light grids and light curtains.

U.S. Pat. No. 4,708,920 discloses a modified beaded sheeting wherein a set of axial markings are formed in the sheeting by laser irradiation at a specific angle, each marking being located at the rear of a microlens. The sheeting thus bears a directional half-tone image composed of the axial markings and viewable, in only a selected cone of observation, in retroreflected light. Directional images such as this are widely used as anticounterfeiting measures for motor vehicle license plates.

Traditional microlenses are formed by flowing a microlens resist material. A positive photoresist is lithographically printed to form a structure of a predetermined geometrical shape, typically a square or rectangle. The microlens resist is then baked at a temperature above the doped glass transition temperature such that the microlens resist flows and the structure “sags” resulting in a curved microlens with a radius of curvature. However, the process of microlens resist flow is very difficult to control. The final shape of the microlens depends on variations in the material causing significant differences in the flow patterns of the microlens resist material, hence making it very difficult to create arrays of microlenses with the same curvature and dimensions.

In another method, an original plate of a microlens is fabricated by an electron-beam lithography method or a metal-plate etching method. Lens material is deposited on the original plate and the deposited lens material is then separated. In these methods, the microlens can be reproduced by molding, variations between lots are unlikely to occur, and the microlens can be fabricated at low cost, however, an electron-beam lithographic apparatus is a rather expensive device, requiring vast investment in equipment. Furthermore, it is difficult to fabricate a mold having a large area because the electron beam impact area is limited.

Still further, in the metal-plate etching method, since an isotropic etching using a chemical reaction is principally employed, etching of the metal plate into a desired profile cannot be achieved if composition and crystalline structure of the metal plate vary even slightly. In addition, to prevent over-etching, the plate is washed immediately after a desired shape is obtained. When a minute microlens is to be formed, a deviation of the actual shape from the desired shape is possible due to undesired etching which continues during the time period lasting from when the desired profile is obtained to the time when the metal plate is washed.

In addition, the above methods suffer from severe transparency limitation due to the use of resin.

A method for producing an all-doped glass planar microlens, employs a reactive ion etching (RIE) technique. A resin layer (photoresist layer) is formed on the surface of a doped glass substrate. Exposure is conducted upon the resin layer with a gray scale mask through which a certain amount of light is transmitted, and thereby the exposure amount is partially varied. Next, the resin layer is made to have a number of nearly spherical convex portions through a development process. The surface of the doped glass substrate is removed together with the resin layer by applying RIE to the resin layer, and thereby an all-doped glass planar microlens is obtained. In this method however, the lens portion formed on the surface of the doped glass substrate has a thickness nearly equal to the thickness of the resin layer. In a case where the height of the convex portion of the lens or the depth of the concave portion is large, it is extremely difficult to uniformly form a resin layer (photoresist layer) having a thickness corresponding to the thickness of the lens as desired on the doped glass substrate. Further, since the convex portions formed through a radiant exposure through a gray scale mask or a melting of a resist remaining in an insular shape are limited to a predetermined shape are formed, the precise shape of the lens as desired cannot be accurately obtained.

An additional method for fabrication of microlenses, includes the use of a focused continues wave (CW) laser beam for locally heating a semiconductor-doped glass (SDG) [U.S. Pat. Nos. 5,604,635 and 5,768,022; G. Beadie and N. M. Lawandy, Optics Lett., 20, 2153 (1995); A. Y. Smuk, N. M. Lawandy, Optics Lett., 22, 1030 (1997); G. Beadie, W. S. Rabinovich, J. Sanghera, I. Aggarwal, Optics Commun., 152, 215 (1998)]. The formation of the microlens occurs due to the local melting of a subsurface layer of the doped glass. It was suggested that the doped glass melting is caused by an increase of the light absorption with temperature. Thus, when laser radiation heats the doped glass the light penetration depth decreases, and in spite of the thermal diffusion, the process of heat deposition becomes increasingly localized at the surface of the doped glass. This thermal runaway causes the host doped glass to melt locally under relatively low-power focused radiation. Because of the lower density of the molten doped glass compared with that of the solid doped glass, the material wells out and solidifies forming a microlens.

SDG microlenses, however, are not transparent to light having a short wavelength (e.g., blue light), hence intrinsically impose rather severe limitations on the application in which microlenses are to be employed.

In a similar method [K. Piglmayer, E. Arenholz, C. Ortwein, N. Arnold, D. Bauerle, Appl. Phys. Lett., 73, 847 (1998)], single pulses of ultra violet (UV) laser are used to locally heat polymers. The formation of the microlens in the polymer occurs due to surface amorphization and additional volume increase of polymer. The formation of polymer hillock can also be described as a purely thermal process. Such description allowed to relate ablation both with the total dose of irradiation and with the duration of laser pulse, and to evaluate ablation threshold. Nevertheless, the quality of polymeric microlenses manufactured by this method is far from being sufficient for most applications.

Another manufacturing method of interest is disclosed in an article entitled “Mechanism of Microlens Formation in Quantum Dot Doped glasses Under Continuous-Wave Laser Irradiation”, by Yuri Kaganovskii, Irena Antonov, Fredrick Bass, Michael Rosenbluh, and Audrey Lipovskii, published in J. Appl. Phys., 89:8273 (2001), the contents of which are hereby incorporated by reference.

In this method, a doped glass, embedded with copper nanoparticles, is exposed to a focused continuous wave (CW) laser radiation, resulting in controllable formation of microlenses on the surface of the doped glass. Although in this method relatively low laser powers are required for the process, there are several limitations which are to be addressed, which limitations are primarily related to the use of copper nanoparticles.

First, in order to excite the copper atom, a laser beam having a relatively long wavelength is to be used, typically a yellow laser beam. The relatively long wavelength limits the accuracy of the process, hence bounds the attainable size of microlenses from below.

Second, copper nanoparticles can only be embedded on the surface of the doped glass, as opposed, e.g., to the SDG in which bulk contamination is achieved. A skilled artisan would appreciate that this limitation on the manufacturing process affects possibilities of the type of products that can be produced and the quality of the final product.

Third, it is recognized that the use of copper nanoparticles has severe environmental implications. Many environmental reports reviewing the sources and emissions of copper, warn about its toxicological effects on soil microorganisms, plants, animals and humans.

A fourth limitation is directed at the method itself. Although this method teaches the use of CW laser beam on a doped glass having copper, it does not provide a sufficiently accurate procedure for calculating the laser beam parameters which are necessary for optimizing the shape and the size of the final product.

There is thus a widely recognized need for, and it would be highly advantageous to have, a method of forming microlenses devoid of the above limitations.

### SUMMARY OF THE INVENTION

According to one aspect of the present invention there is provided a method of forming a microlens, comprising providing a doped glass having at least one metallic component other than copper, and locally irradiating the doped glass by a continuous wave laser beam, so as to melt a portion of the doped glass, thereby to form the microlens.

According to another aspect of the present invention there is provided a method of forming a microlens array, comprising: (a) providing a doped glass having at least one metallic component other than copper; (b) selecting a plurality of locations on the doped glass; and (c) at each location of the plurality of locations, irradiating the doped glass by a continuous wave laser beam, so as to melt a portion of the doped glass, thereby to form a microlens at the location; thereby forming a microlens array.

According to yet another aspect of the present invention there is provided a microlens formed in a doped glass having at least one metallic component other than copper, the microlens being formed in the doped glass by local radiation of a continuous wave laser beam, selected so as to melt a portion of the doped glass, thereby to form the microlens.

According to further features in preferred embodiments of the invention the described below, the microlens is transparent to light having a wavelength from about 350 nanometers to about 2 micrometers.

According to still further features in the described preferred embodiments the microlens is transparent to light having a wavelength from about 400 nanometers to about 2 micrometers.

According to still another aspect of the present invention there is provided a microlens formed in a doped glass having at least one metallic component other than copper, the microlens is transparent to light having a wavelength from about 350 nanometers to about 2 micrometers.

According to further features in preferred embodiments of the invention the described below, the at least one metallic component forms at least one diffusion layer of metallic nanoclusters.

According to still further features in the described preferred embodiments the at least one metallic component forms a bulk in the doped glass.

According to still further features in the described preferred embodiments the at least one metallic component forms a plurality of crystallites surrounding the microlens.

According to still further features in the described preferred embodiments a radius of the microlens is from about 0.7 micrometer to about 100 micrometers.

According to still further features in the described preferred embodiments a height of the microlens is from about 0.07 micrometer to about 10 micrometers.

According to an additional aspect of the present invention there is provided a microlens array, comprising a plurality of microlenses formed in a doped glass having at least one metallic component other than copper, wherein each of the plurality of microlenses of the microlens array is transparent to light having a wavelength from about 350 nanometers to about 2 micrometers.

According to yet an additional aspect of the present invention there is provided an optical device having at least one microlens array, the microlens array comprising a plurality of microlenses formed in a doped glass having at least one metallic component other than copper, wherein each of the plurality of microlenses of the microlens array is transparent to light having a wavelength from about 350 nanometers to about 2 micrometers.

According to further features in preferred embodiments of the invention the described below, the optical device is selected from the group consisting of an imaging device, a microscope, a confocal microscope, a telescope, a magnifying device, an optical interconnecting unit, a telecommunications device, a micro-optical device, an integrated optical circuit, a display device, a multi LCD projection device, a single LCD projection device, a LED based display device, an integral photography device, a retroreflector array, a surface characterization device, and a wavefront sensing device.

According to still further features in the described preferred embodiments, each of the plurality of microlenses of the microlens array is transparent to light having a wavelength from about 400 nanometers to about 2 micrometers.

According to still further features in the described preferred embodiments the at least one metallic component forms a plurality of crystallites surrounding at least a portion of the plurality of microlenses.

According to still further features in the described preferred embodiments a thickness of the plurality of crystallites is from about 10 nanometers to about 200 nanometers.

According to still further features in the described preferred embodiments a radius of at least a portion of the plurality of microlenses is from about 0.7 micrometer to about 100 micrometers.

According to still further features in the described preferred embodiments a height of at least a portion of the plurality of microlenses is from about 0.07 micrometer to about 10 micrometers.

According to still an additional aspect of the present invention there is provided a method of forming a microlens, comprising: (a) doping a glass with at least one metallic component other than copper, thereby providing a doped glass; and (b) locally irradiating the doped glass by a continuous wave laser beam, so as to melt a portion of the doped glass, thereby to form the microlens.

According to a further aspect of the present invention there is provided a method of forming at least one microlens on a doped glass having at least one metallic component other than copper, the method comprising: (a) selecting a shape and size for the microlens; (b) using physical characteristics of the doped glass for calculating at least one laser beam parameter, the at least one laser beam parameter being suitable for providing the shape and size of the at least one microlens; and (c) locally irradiating the doped glass by a continuous wave laser beam having the at least one laser beam parameter, so as to melt a portion of the doped glass, thereby to form the at least one microlens.

According to yet a further aspect of the present invention there is provided a method of forming at least one microlens having a predetermined shape and size, comprising: (a) doping a glass with at least one metallic component other than copper, thereby providing a doped glass; (b) using physical characteristics of the doped glass for calculating at least one laser beam parameter, the at least one laser beam parameter being suitable for providing the predetermined shape and size of the at least one microlens; and (c) locally irradiating the doped glass by a continuous wave laser beam having the at least one laser beam parameter, so as to melt a portion of the doped glass, thereby to form the at least one microlens.

According to further features in preferred embodiments of the invention the described below, the methods further comprising repeating step of locally irradiating the doped glass, a plurality of times, each time in a different location on the doped glass, to form a microlens array. According to still further features in the described preferred embodiments the calculating the at least one laser beam parameter comprises calculating a temperature distribution of the doped glass and using the temperature distribution for calculating the at least one laser beam parameter.

According to still further features in the described preferred embodiments the doped glass is characterized by a predetermined optical absorption spectrum.

According to still further features in the described preferred embodiments the shape and size is defined by at least one of a radius, a height and a profile.

According to still further features in the described preferred embodiments the laser beam is selected from the group consisting of a blue laser beam and an ultraviolet laser beam.

According to still further features in the described preferred embodiments the laser beam is characterized by a wavelength of 350 to 540 nanometers.

According to still further features in the described preferred embodiments the laser beam has an average power from about 10 to about 100 milliwatts.

According to still further features in the described preferred embodiments at least one of an exposure duration, a power, an impinging angle, a polarization, a divergence and an intensity distribution of the irradiation is selected so as to provide the microlens with a predetermined radius.

According to still further features in the described preferred embodiments at least one of an exposure duration, a power, an impinging angle, a polarization, a divergence and an intensity distribution of the irradiation is selected so as to provide the microlens with a predetermined height.

According to still further features in the described preferred embodiments at least one of an exposure duration, a power, an impinging angle, a polarization, a divergence and an intensity distribution of the irradiation is selected so as to provide the microlens with a predetermined prismatic properties.

According to still further features in the described preferred embodiments at least one of an exposure duration, a power, an impinging angle, a polarization, a divergence and an intensity distribution of the irradiation is selected so as to provide the microlens with a predetermined focal length.

According to still further features in the described preferred embodiments at least one of an exposure duration, a power, an impinging angle, a polarization, a divergence and an intensity distribution of the irradiation is selected so that the microlens is transparent to visible light.

According to still further features in the described preferred embodiments at least one of an exposure duration, a power, an impinging angle, a polarization, a divergence and an intensity distribution of the irradiation is selected so that the microlens is transparent to infrared light.

According to still further features in the described preferred embodiments at least one of an exposure duration, a power, an impinging angle, a polarization, a divergence and an intensity distribution of the irradiation is selected so that the microlens is transparent to light having a wavelength from about 350 nanometers to about 2 micrometers.

According to still further features in the described preferred embodiments at least one of an exposure duration, a power, an impinging angle, a polarization, a divergence and an intensity distribution of the irradiation is selected so that the microlens is transparent to light having a wavelength from about 400 nanometers to about 2 micrometers.

According to still further features in the described preferred embodiments the locally irradiating the doped glass is by a laser device selected from the group consisting of a solid state laser device, a liquid laser device and a gaseous laser device.

According to still further features in the described preferred embodiments the locally irradiating the doped glass is effected by a procedure selected from the group consisting of irradiating by an Argon-based laser device, irradiating by a blue diode laser device, irradiating by a second harmonic of a Nd:YAG laser device, irradiating by a third harmonic of a Nd:YAG laser device and irradiating by an excimer laser device.

According to still further features in the described preferred embodiments a duration of the irradiation is from about 0.1 millisecond to about 10 seconds.

According to still further features in the described preferred embodiments the at least one laser beam parameter is selected from the group consisting of a wavelength, a polarization, a divergence, a power, an exposure duration, an impinging angle and an intensity distribution.

According to still further features in the described preferred embodiments the physical characteristics are selected from the group consisting of thermal diffusivity, thermal conductivity, heat capacity, glass viscosity temperature dependence and absorption coefficient.

According to still further features in the described preferred embodiments the calculating the temperature distribution comprises solving a heat diffusion equation.

According to still further features in the described preferred embodiments the heat diffusion equation is a steady-state heat diffusion equation.

According to still further features in the described preferred embodiments the heat diffusion equation is a non-linear heat diffusion equation, being characterized by a non-linear term.

According to still further features in the described preferred embodiments the non-linear term comprises a temperature dependent thermal diffusivity.

According to still further features in the described preferred embodiments the temperature dependent thermal diffusivity has an exponential form.

According to still further features in the described preferred embodiments the method further comprising performing a linearization procedure on the non-linear heat diffusion equation, thereby constructing a linear differential equation.

According to still further features in the described preferred embodiments the linearization procedure comprises introducing an integrated function and substitution the integrated function in the non-linear heat diffusion equation.

According to still further features in the described preferred embodiments the integrated function comprises an integral of the temperature dependent thermal diffusivity.

According to still further features in the described preferred embodiments the calculating the at least one laser beam parameter comprises generating a graphical representation of the temperature distribution, and detecting portions of the graphical representation corresponding to a formation of the at least one microlens.

According to still further features in the described preferred embodiments the graphical representation comprises a plurality of isotherms.

According to still further features in the described preferred embodiments the portions of the graphical representation comprises at least one isotherm of the plurality of isotherms.

According to still further features in the described preferred embodiments the doping the glass with the at least one metallic component comprises: (i) exchanging ions of the glass with ions of the at least one metallic component; and (ii) generating conditions for growth of metallic nanoclusters of the at least one metallic component, thereby providing at least one diffusion layer of metallic nanoclusters.

According to still further features in the described preferred embodiments the doping the glass with the at least one metallic component comprises (i) providing a molten environment and mixing the at least one metallic component therein, so as to provide a mixed molten environment; and (ii) cooling the mixed molten environment so as to form a glass having a bulk of at least one metallic component doped therein.

According to still further features in the described preferred embodiments the glass melt comprises at least one component selected from the group consisting of powdered silica, sodium carbonate, lithium carbonate, boron oxide, zirconium oxide, cerium oxide, aluminum oxide and arsenic oxide.

According to still further features in the described preferred embodiments a composition of the glass is selected so as to allow ion exchange between the glass and the at least one metallic component.

According to still further features in the described preferred embodiments the at least one metallic component is selected from the group consisting of silver, gold, nickel, ferrum, cerium, and platinum.

According to still further features in the described preferred embodiments the ions of the glass are alkali ions.

According to still further features in the described preferred embodiments the ions of the glass are selected from the group consisting of sodium ions, lithium ions, rubidium ions, cesium ions and potassium ions.

According to still further features in the described preferred embodiments the exchanging ions of the glass with ions of the at least one metallic component is by positioning the glass in a molted environment comprising a mix alkaline and the at least one metallic component.

According to still further features in the described preferred embodiments the molted environment comprising at least one combination selected from the group consisting of AgNO₃, AgNO₃ and NaNO₃, AgNO₃ and KNO₃, AgNO₃ and (NaNO₃+KNO₃).

According to still further features in the described preferred embodiments the method further comprises further exchanging ions of the glass with ions present in a molted salt containing alkaline ions.

According to still further features in the described preferred embodiments the molted environment comprises about 5 parts of the AgNO₃ and about 95 parts of the NaNO₃.

According to still further features in the described preferred embodiments the doping the glass is done so as that a concentration of the at least one metallic component within a predetermined region of the doped glass is at least 5 percent by weight.

According to still further features in the described preferred embodiments the doping the glass is done so as that a concentration of the at least one metallic component within a predetermined region of the doped glass is at least 10 percent by weight.

According to still further features in the described preferred embodiments the step of exchanging ions is performed at a temperature of at least 160 degrees centigrade.

According to still further features in the described preferred embodiments the generating the conditions for the growth of the metallic nanoclusters is by annealing the doped glass in Hydrogen atmosphere.

According to still further features in the described preferred embodiments a temperature of the Hydrogen atmosphere is from about 150 degrees centigrade to about 250 degrees centigrade.

According to still further features in the described preferred embodiments a diffusion depth of the at least one diffusion layer is from about 3 micrometers to about 100 micrometers.

According to still further features in the described preferred embodiments the doping the glass is characterized by a dopant type, dopant concentration level, a doping time and a doping temperature, and further wherein at least one of the dopant type, the dopant concentration level, the doping time and the doping temperature is selected so as to provide the doped glass with a predetermined optical absorption spectrum.

According to still further features in the described preferred embodiments the predetermined optical absorption spectrum is such that the doped glass absorbs laser radiation having sufficiently small wavelength.

According to still further features in the described preferred embodiments the predetermined optical absorption spectrum is characterized by a peak in a green range of wavelengths.

According to still further features in the described preferred embodiments the predetermined optical absorption spectrum is characterized by a peak in a blue range of wavelengths.

According to still further features in the described preferred embodiments the predetermined optical absorption spectrum is characterized by a peak in an ultraviolet range of wavelengths.

According to still further features in the described preferred embodiments the predetermined optical absorption spectrum is characterized by a peak in about 410 nanometers.

According to still further features in the described preferred embodiments the predetermined radius is from about 0.7 micrometer to about 100 micrometers.

According to still further features in the described preferred embodiments the predetermined height is from about 0.07 micrometer to about 10 micrometers.

According to still further features in the described preferred embodiments the method further comprising focusing the laser beam.

According to still further features in the described preferred embodiments the focusing is by an optical element selected from the group consisting of a microscope objective lens, a GRIN lens and a diffraction lens.

According to still further features in the described preferred embodiments the focusing is performed so as to control at least one of a shape and size, a transparency and prismatic properties of the microlens.

According to still further features in the described preferred embodiments the laser beam is characterized by a central-symmetrical radial intensity distribution.

According to still further features in the described preferred embodiments the central-symmetrical radial intensity distribution comprises a Gaussian.

According to still further features in the described preferred embodiments an effective radius of the laser beam, prior to impinging on the doped glass, is in a micrometer scale.

The present invention successfully addresses the shortcomings of the presently known configurations by providing a transparent microlens, a transparent microlens array and a method of making the same.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flowchart of method of forming a microlens, according to a preferred embodiment of the present invention;

FIGS. 2a-b are schematic illustrations of a doped glass having a metallic component embedded therein, according to a preferred embodiment of the present invention;

FIG. 2c is a schematic illustration of a side view of a microlens, according to a preferred embodiment of the present invention;

FIG. 2d is a schematic illustration of a top view of a microlens, according to a preferred embodiment of the present invention;

FIG. 3 is a is a flowchart of method of forming a microlens array, according to a preferred embodiment of the present invention;

FIG. 4 is a flowchart of method of doping a glass and forming a microlens thereon, according to a preferred embodiment of the present invention;

FIG. 5 is a flowchart of a method of forming at least one microlens on a doped glass, further including the calculation of at least one laser beam parameter, suitable for providing the shape and size of the formed microlens, according to a preferred embodiment of the present invention;

FIG. 6 is a is a flowchart of a method of doping a glass and forming at least one microlens having a predetermined shape and size thereon, further including the calculation of at least one laser beam parameter, suitable for providing the shape and size of the formed microlens, according to a preferred embodiment of the present invention;

FIG. 7 is a schematic illustration of a microlens array, comprising a plurality of microlenses formed in a doped glass;

FIG. 8 shows variation of the refractive index with depth after a 1 hour of ion exchange at a temperature of 340° C.;

FIG. 9 shows optical absorption spectra of three Ag-doped glasses, an Ag-doped glass sample prior to any annealing process (designated 1), an Ag-doped glass sample subjected to 1 hour of annealing process at temperature of 180° (designated 2) and an Ag-doped glass sample subjected to 0.5 hour of annealing process at temperature of 200° (designated 3);

FIGS. 10a-c are atomic force microscope images of microlenses obtained at a laser power of 60 mW, for exposure times of 1 millisecond (a), 20 milliseconds (b) and 1000 millisecond (c);

FIG. 11a shows radii of lenses fabricated at laser powers of 37, 43, 54 and 67 mW, as a function of exposure time;

FIG. 11b shows a square root of a characteristic time as a function of a saturation radius;

FIG. 12 shows transmission percentage at a wavelength of 488 nm of a microlens during its formation, as a function of the exposure time for laser powers of 27.3, 33, and 40 mW;

FIG. 13a shows the absorption coefficient as a function of a depth, measured from the surface of the doped glass, calculated for three different values of a dimensionless products α₀l 1.04, 1.35 and 1.95;

FIG. 13b shows a temperature distribution on the surface of the doped glass, as a function of the radial distance from the center of a laser beam, for the three different values of a dimensionless product of FIG. 13a;

FIG. 13c shows a temperature distribution at the center of a laser beam, as a function of the depth, for the three different values of a dimensionless product of FIG. 13a;

FIG. 14a shows lens radii as a function of diffusion depth for a dimensionless product value of 1.04, calculated at laser powers of 36, 45, 54 and 56 mW, together with experimental points measured at the same laser powers;

FIG. 14b shows lens radii as a function of diffusion depth for a dimensionless product value of 1.95, calculated at laser powers of 33, 36, 43, 45 and 54 mW, together with experimental points measured at the same laser powers; and

FIG. 15 shows experimental dependence of the microlens radius on the laser power, for two glasses, in comparison with theoretical predictions.

### DESCRIPTION OF THE PREFERRED EMBODIMENTS

The present invention is of a microlens, a microlens array and a method of making the microlens and the microlens array which can be used for collecting and focusing light in various optical applications. Specifically, the present invention can be used in many integrated optical circuits and optical devices for the purpose of imaging, photographing, displaying, projecting, illuminating, communicating, wavefront sensing and the like. The present invention is further of an optical device incorporating the microlens and/or the microlens array.

The principles and operation of a method of forming a microlens, according to the present invention, may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

According to one aspect of the present invention there is provided a method of forming a microlens.

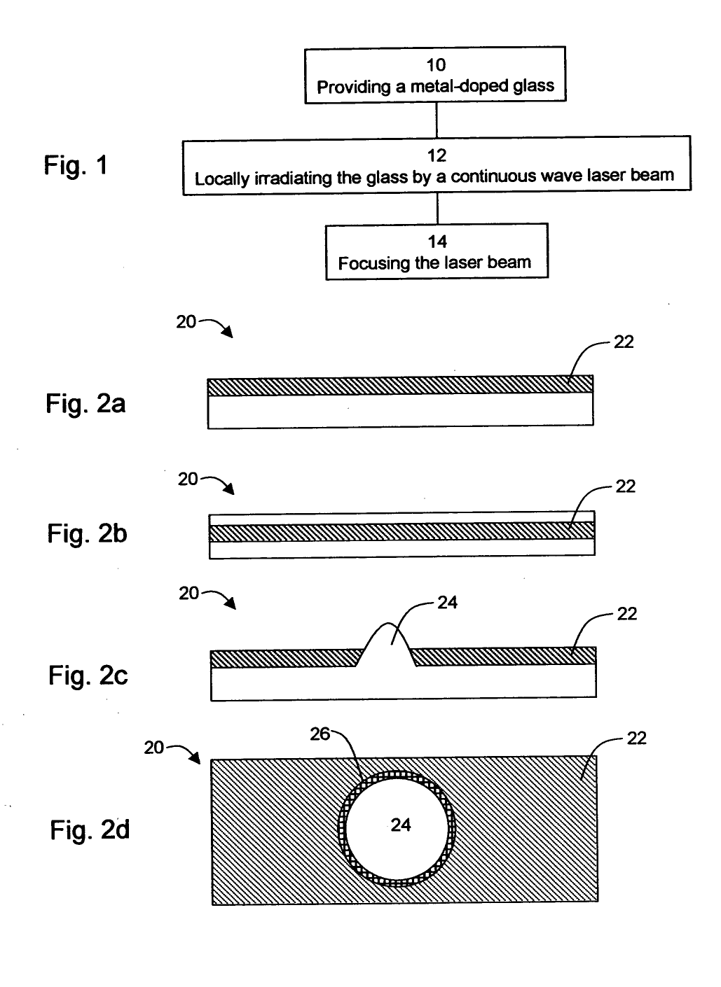

Referring now to the drawings, the method comprises the following method steps which are illustrated in the flowchart of FIG. 1. Hence, in a first step, designated by Block 10, a doped glass, doped with at least one metallic component other than copper is provided. The metallic component is preferably characterized by relatively large capability of reducing. A preferred metallic component is silver, however other metallic components, having high capability of reducing, such as gold, nickel, ferrum, cerium and platinum are not excluded. As used herein the terms “doped glass” and “metal-doped” doped glass refers to a doped glass having at least one metallic component other than copper.

In a second step of the method, designated by block 20, the doped glass is locally irradiated by a continuous wave laser beam, so as to melt a portion of doped glass, thereby to form the microlens.

Before providing a further detailed description of the method of forming the microlens, as delineated hereinabove and in accordance with the present invention, attention will be given to the advantages and potential applications offered thereby.

A particular feature of the present invention is the metal-doped glass. When irradiated by the laser beam, the metallic component absorbs light and heats the doped glass. In the preferred embodiment in which silver is used as the metallic component, the laser beam can have a short wavelength (e.g., blue or ultraviolet) which allows high-resolution formation of microlenses of small size and enhanced precision, as compared to the use of copper (see Kaganovskii et al.).

Being made of essentially the glass material itself, the microlens of the present invention is substantially permanent and temperature stable. In this respect, the microlens of the present invention has a significant advantage over many other prior art microlens (e.g., lenses made of epoxy drops), where the lens material is applied onto the glass. These lenses are less stable and have relatively shorter life times comparing to the microlens of the present invention.

Additionally, unlike other SDG methods, where the semiconductor nanocrystallites or microcrystallites, embedded within the glass matrix, limits the wavelengths to which the final product is transparent, as will be shown, the preferred microlens of the present invention is substantially transparent to infrared, visible and ultraviolet light. Moreover, in SDG methods the semiconductor dopant is selected according to the transmitted wavelength of interest. Thus, in an SDG microlens array, not only the microlenses are transparent to the wavelength of interest, but the entire substrate. As further detailed hereinunder, the use of metal-doped glass (e.g., silver, gold aluminum, etc.), allows manufacturing of microlens arrays in which the microlenses are transparent to a wide spectrum of wavelengths while inter-microlens spaces are substantially opaque. One would appreciate the advantage of such microlens-array, as most applications in which a microlens-array is used, light rays which are not transmitted through the microlens cause an unwanted background and distortions in the final image or other information.

Doping a glass with silver is a known and relatively easy procedure. As stated, either a bulk doping or a surface doping can be used. Thus, depending on the specific application, the manufacturer can select the type of doping for optimal performance of the final product. This advantage is neither possessed by SDG method where only bulk doping can be employed nor by copper-doped glass, where only surface doping can be employed.

Another particular feature of the present invention, which is further detailed hereinunder, is a well-defined procedure for selecting the laser parameters which are optimal for formation of a microlens having a given shape and size. Such a procedure provides a better control on the shape and size of the final product. It will be appreciated by one ordinarily skilled in the art that different applications favor microlenses with different shapes and sizes.

In addition, according to a preferred embodiment of the present invention, the metallic component of the doped glass is selected environmental “friendly” hence overcoming the limitation of copper-doped glass in this respect.

Referring now again to the drawings, FIGS. 2a-b illustrate a doped glass 20 having a metallic component 22 embedded therein. According to a preferred embodiment of the present invention the metallic component (e.g., the silver) may forms either a diffusion layer (FIG. 2a) or a bulk (FIG. 2b) of metallic nanoclusters in the doped glass substrate.

For a diffusion layer doping, as the metallic component is not deposited onto the glass but being doped therein, the concentration of the diffusion layer varies is a monotonic function, typically decaying as complementary error function, of the depth into which the dopant penetrates. This monotonic function has an effective diffusion depth, which characterize the thickness of the diffusion layer. According to a preferred embodiment of the present invention the diffusion depth of the diffusion layer ranges from about 3 micrometers to about 100 micrometers. The concentration the metallic component within the diffusion layer is preferably at least 3 percent, more preferably at least 10 percent by weight.

As used herein the term “about” refers to ±10%.

Doped glass 20 is preferably characterized by a predetermined optical absorption spectrum. As demonstrated in the Examples section that follows, it has been found that an optical absorption spectrum having a peak in about 410 nanometers is adequate (see FIG. 9 in the Examples section). It is to be understood that this optical absorption spectrum is not the only suitable optical absorption spectrum and that other spectra, are not excluded, for example, optical absorption spectra which are characterized by peaks in the blue or ultraviolet ranges of wavelengths. Such spectra allow the use of blue or ultraviolet radiation, thereby to enhance the precision of the process. It is to be understood that this spectrum is not to be considered as limiting and other similar spectra may be selected. Thus, according to a preferred embodiment of the present invention, the optical absorption spectrum of doped glass 20 is such that doped glass 20 absorbs laser radiation having sufficiently small wavelength.

Following is a description of the formation of a microlens, with reference to FIGS. 2c-d, which are, respectively, simplified illustrations of a side view and a top view of microlens 24 formed on doped glass 20. Although the illustration in FIG. 2c is of a microlens formed on a glass in which metallic component 22 forms a diffusion layer, it is to be understood, that it not intended to limit the scope of the present invention to this type of doping, and similar illustration can be made by one ordinarily skilled in the art for bulk doping.

Hence, during the exposure of doped glass 20 to the laser radiation the temperatures at the laser spot increase to extremely high levels so that a small volume of the irradiated area melts and the glass viscosity decreases significantly. Due to the density difference between the liquefied volume and its surrounding solid volume, the material in the liquefied volume wells out and, once solidifies, forms a microlens.

A temperature gradient is formed in the hot liquefied region, causing the metallic nanoparticles to move, together with a layer of liquefied glass, in a direction dictated by the temperature gradient from the apex of the liquefied region to its periphery. This motion continues until the metallic particles and the layer of liquefied glass reach the periphery where the glass is solid. As a result, crystallites 26 of metallic component 22 are formed on the surface surrounding the microlens 24. Another portion of metallic component 22 which was not moved by the temperature gradient dissolves.

At the same time, the transparency of doped glass 20 rapidly increases, allowing transmission of light therethrough. After a sufficient duration of exposure, the transparency reaches a saturation level which depends on various parameters of the laser beam, such as the power, the intensity distribution, etc. The increase of the lens transmission is caused by the partial dissolution of metallic component 22 and the radial motion thereof to the periphery of the irradiated area, as explained above. Both the dissolution of the clusters and the radial motion thereof are accelerated at higher laser power and thus leads to the increase of the transparency of microlens 24 with power. Beside the power, other parameters of the laser beam, such as, but not limited to, wavelength, power, exposure duration, impinging angle, polarization, divergence and intensity distribution, also affect the transparency of microlens 24.

Thus, according to a preferred embodiment of the present invention, the laser beam parameters are selected so that microlens 24 is transparent to a wide spectrum of wavelengths, preferably from ultraviolet to infrared, more preferably visible light.

In another embodiment, the laser beam parameters are selected so as to provide microlens 24 with a predetermined prismatic properties. This embodiment is particularly useful in applications in which different wavelengths are to be focused on different locations, for example a single LCD projection device.

While reducing the present invention to practice it has been found by the Inventors of the present invention that various parameters of the CW laser beam also affects the shape and size (e.g., the radius, height, profile) and other prosperities such as, but not limited to, the focal length of the formed microlens. Thus, according to a preferred embodiment of the present invention, the shape and size of microlens 24 is controlled by a judicious selection of the laser beam parameters. For example, larger radius may be achieved by longer duration and/or larger power of laser radiation. Similarly, the height of microlens 24 also increases with the duration and power of the laser radiation. A more detailed description of a procedure for selecting the optimal laser parameters for a given shape and size of microlens 24 is provided hereinafter.

According to a preferred embodiment of the present invention, any laser device may be used for providing the CW laser radiation, such as, but not limited to, a solid state laser device, a liquid laser device and a gaseous laser device. In any case the laser device is selected according to the desired wavelength of the laser radiation, which, as stated, is preferably small (e.g., 350 to 540 nanometers). For example, blue laser radiation (e.g., 480-500 nanometers) can be provided by an Argon-based laser device. Other devices for providing the laser radiation include, but are not limited to, a Nd:YAG laser device (preferably the second or the third harmonic thereof), a blue laser diode device, an excimer laser device and the like.

Referring now again to FIG. 1, in a third step of the method, designated by block 14, the laser beam is focused, e.g., by a microscope objective lens, a gradient index (GRIN) lens, a diffraction lens or any other optical element capable of focusing the beam onto doped glass 20. The focusing of the beam is for providing a higher energy density per unit area to doped glass 20, thereby enhancing the efficiency of the formation process. It is to be understood that the third step and the second step are performed contemporaneously. Additionally, as the focusing optical element practically determine the strength of the interaction between the laser beam and doped glass 20, this may be used for controlling the shape and size, the transparency and/or the prismatic properties of microlens 24.

Employing the above method on doped glass 20 a plurality of times results in a formation of a plurality of microlenses.

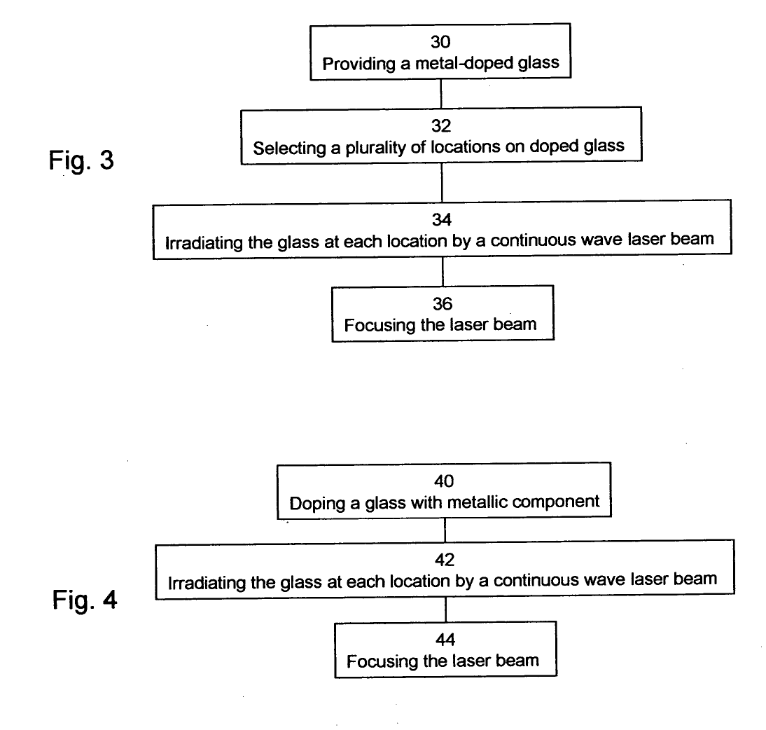

Thus, according to another aspect of the invention there is provided a method of forming a microlens array, comprising the following method steps which are illustrated in the flowchart of FIG. 3. Hence, in a first step, designated by Block 30 a doped glass, doped with at least one metallic component other than copper is provided. In a second step, designated by Block 32, a plurality of locations are selected on the doped glass, and in a third step, designated by Block 34, each location is irradiated by a continuous wave laser beam, as further detailed hereinabove. Similar to the above method, an additional step may be employed contemporaneously with the third step. In this step, designated by Block 36, the laser beam is focused by a suitable optical element.

According to an additional aspect of the present invention, there is provided a method of doping a glass and forming a microlens thereon. The method comprises the following method steps which are illustrated in the flowchart of FIG. 4.

Referring to FIG. 4, in a first step of the method, designated by block 40, a glass is doped with at least one metallic component other than copper (e.g., metallic component 22), to provide a doped glass (e.g., doped glass 20). This step is further detailed hereinbelow and exemplified in the Example section that follows. In a second step of this method, designated by block 42, the doped glass is locally irradiated by a continuous wave laser beam as further detailed hereinabove. Preferably, this method further comprises a third, optional, step, designated in FIG. 4 by block 44, in which the laser beam is focused by a suitable optical element similar to the respective steps in the above methods.

Any doping technique can be used for doping the glass with the metallic component. A typical doping technique is generally characterized by several controllable parameters such as, but not limited to, a dopant type, a dopant concentration level, a doping time and a doping temperature. According to a preferred embodiment of the present invention at least one of these parameters is selected so as to provide the doped glass with a predetermined optical absorption spectrum, as further detailed hereinabove.

In one preferred embodiment, ion exchange doping technique is used [J. Linares, D. Sotelo, A. A. Lipovskii, V. V. Zhurihina, D. K. Tagantsev, J. Turunen, Optical Materials, 14:145 (2000)]. In this embodiment, the composition of the glass is preferably selected so as to allow ion exchange between doped glass and at least one metallic component.

Thus, in the doping process, ions of the glass, e.g., alkali ions (such as, but not limited to, sodium, lithium, rubidium, cesium, potassium etc.), preferably sodium ions, are first exchanged with ions of the metallic component. This may be done, for example, by positioning the glass in an appropriate molten environment, such as, but not limited to, an environment comprising AgNO₃, AgNO₃ and NaNO₃, AgNO₃ and KNO₃, AgNO₃ and (NaNO₃+KNO₃) and the like.

A typical temperature in which the process of ion exchange is performed is at least 160° C.

Once the ions of the glass are exchanged by ions of the metallic component, appropriate conditions are generated for growth of metallic nanoclusters of the metallic component, so that a diffusion layer of metallic nanoclusters is formed. This may be done, for example, by annealing the doped glass in Hydrogen atmosphere. A typical temperature of the Hydrogen atmosphere is from about 150° C. to about 250° C. The nanoclusters may also be form via interaction of the metallic component with other ions of the glass, e.g., cerium.

According to a preferred embodiment of the present invention the method may further comprise exchanging ions of the glass with ions present in a molted salt containing alkaline ions. This embodiment may be used so as to form a buried layer, e.g., for reducing losses and scattering.

In another embodiment, bulk doping is used. In this embodiment, either commercial available glasses or especially designed and melted glasses can be used. Suitable glasses for bulk doping contain sufficient amount of alkaline ions. The procedure of preparing a bulk dope in a glass is known in the art, and generally comprises mixing metallic component 22 with a glass melt to provide a mixed molten environment, and cooling the mixed molten environment to form a glass having a bulk of metallic component 22 doped therein. According to a preferred embodiment of the present invention the glass melt may comprises any component suitable for bulk doping, such as, but not limited to, powdered silica, sodium carbonate, lithium carbonate, boron oxide, zirconium oxide, cerium oxide, aluminum oxide and arsenic oxide.

The present invention successfully addresses the issue of an appropriate selection of the laser beam parameters, so as to optimize the characteristics of the produced microlens or microlens array.

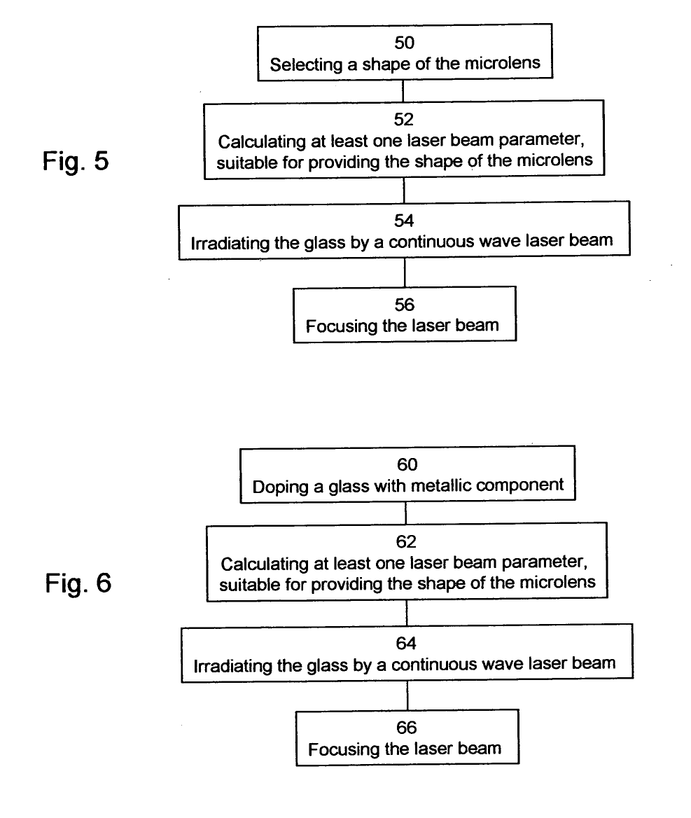

Thus, according to an additional aspect of the present invention, there is provided a method of forming at least one microlens (e.g., a microlens array) on a doped glass having at least one metallic component other than copper, which may be, for example, metallic component 22. The method comprising the following method steps which are illustrated in the flowchart of FIG. 5.

Referring to FIG. 5, in a first step of the method, designated by Block 50 the shape and size for the microlens is selected, which shape and size, may be defined, for example by a radius, a height a profile, or any combination thereof. In a second step of this method, designated by Block 52, physical characteristics (e.g., thermal diffusivity, thermal conductivity, heat capacity, glass viscosity temperature dependence, absorption coefficient etc.) of the doped glass are used for calculating at least one laser beam parameter, suitable for providing the shape and size of the microlens. This step is further detailed hereinbelow and exemplified in the Example section that follows. In a third step, designated by Block 54, the doped glass is locally irradiated by a continuous wave laser beam having the laser beam parameter(s), calculated in the second step, so as to melt a portion of the doped glass, thereby to form the microlens. Similarly to the respective steps in the previous methods, this method preferably comprises an optional, step, designated in FIG. 5 by block 56, in which the laser beam is focused by a suitable optical element. The third step and the optional focusing step are performed contemporaneously, and may be repeated a plurality of times, each time in a different location on the doped glass, so that a microlens array is formed.

Following is a description of the step of calculating the laser beam parameter(s). According to a preferred embodiment of the present invention, first, a temperature distribution of the doped glass is calculated, and thereafter the laser beam parameters are calculated using the temperature distribution. The temperature distribution is preferably calculated from a heat diffusion equation. Broadly speaking, a heat diffusion equation relates the rate of heat change to the heat produced by a source (the laser radiation, in this case) and the temperature gradient.

Specifically, the heat diffusion equation may be written as:

$$\frac{\partial T}{\partial t} = \frac{Q}{c} + div ( κ \vec{∇} T ) , \qquad ( EQ . 1 )$$

where, T is the temperature, t is the time, Q is the heat added by the laser radiation, c is the heat capacity per unit volume and κ is the thermal diffusivity. In the literature, Equation 1 is sometimes written in terms of the thermal conductivity k=ρC_{P}κ, where ρ is the density and C_{P} is the specific heat capacity (per unit mass).

According to a preferred embodiment of the present invention, the solution of the heat diffusion equation is obtained at a steady-state, i.e., when the left hand side of Equation 1 vanishes.

Unlike prior art methods, where the thermal diffusivity, κ, was treated as constant, the present invention provides a solution to Equation 1, in which κ (or equivalently k) is properly taken to be temperature-dependent. Thus, the second term of Equation 1 becomes non-linear, as it involves product of two functions of the temperature, κ(T) and ∇T.

The solution of Equation 1 is preferably performed by performing a linearization procedure thereon, so as to eliminate the non-linearity hence to construct a linear differential equation. This may be done, for example, by comprises introducing an integrated function, θ(T), and substitution it in Equation 1. Preferably, θ(T) is defined as the integral of the thermal diffusivity, κ(T). Thus, κ(T) can be expressed in terms of the integrated function, θ(T), in a differential form:

$$κ ( T ) = {κ}_{0} \frac{\partial θ ( T )}{\partial T} , \qquad ( EQ . 2 )$$

where, κ₀=κ(T₀) is the heat diffusivity at room temperature T₀. Using the identity

$$\frac{\partial θ}{\partial T} ∇ T = ∇ θ \qquad ( EQ . 3 )$$

one obtains a Laplacian, Δ, of the integrated function θ(T), which replaces the divergence of κ∇T, thereby eliminates the non-linearity property of the second term of Equation 1.

A linear differential equation for θ is thus obtained from Equation 1, which linear differential equation can be solved either analytically or numerically. A preferred solution of this equation is provided in the Examples section. One ordinarily skilled in the art would appreciate that a solution for θ corresponds to a solution to the temperature distribution, for example, via an empirical expression for the temperature dependence (e.g., exponential) of the heat diffusivity, κ(T). Being a solution of the diffusion equation, the integrated function, θ, hence also the temperature distribution, depends on the source term Q/c, appearing in Equation 1. As stated, this source term represents the heat provided by the laser beam, thus containing the laser beam parameters which, according to a preferred embodiment of the present invention, are extracted from the solution once obtained.

It is recognized that the temperature distribution of the doped glass includes sufficient information for the microlens formed therein. For example, a temperature distribution having large gradient correspond to a formation of a microlenses of high curvature.

Thus, as the temperature distribution depends on the one hand on the laser beam parameters, and on the other hand on the shape and size of the formed microlens, the present invention successfully provides a well defined procedure for determining the laser beam parameters knowing the desired shape and size of the microlens.

Ideally, a determination of the optimal laser beam parameters would be to invert the solution so as to obtain a numerical or analytical expression for each laser beam parameter, as a function of the shape and size of the microlens. This, may be difficult to achieved, especially when more than one parameter determines the laser beam and more than one parameter determines the microlens shape and size.

Alternatively, the laser beam parameters may be extracted as follows. Since the temperature distribution (i.e., the temperature as a function of position) is known, this distribution may be represented graphically, e.g., by a plurality of isotherms as a function of the position. Then, according to a preferred embodiment of the present invention, portions of the graph corresponding to a formation of a lens are detected, so that for a given solution the shape and size of the formed microlens is obtained.

The designer of the microlens selects an input set of laser beam parameters, solves the diffusion equation and generates the appropriate graphical representation of the solution. From this graphical representation, a shape and size of the microlens to be formed is predicted. The procedure is repeated for another set of laser beam parameters, until the desired shape and size is predicted.

A preferred graphical representation of the temperature distribution is a plurality of isotherms. The value of isotherm defining the microlens depends on the chemical composition of the doped glass. Typically, such isotherm corresponds to a temperature of about 900° C.

According to still another aspect of the present invention, there is provided a method of forming at least one microlens (e.g., a microlens array) having a predetermined shape and size. The method comprising the following method steps which are illustrated in the flowchart of FIG. 6.

Referring to FIG. 6, in a first step of the method, designated by Block 60 a glass is doped with at least one metallic component other than copper (e.g., metalli component 22), as further detailed hereinabove and exemplify in the Examples section that follows. In a second step of this method, designated by Block 62, physical characteristics of the doped glass are used for calculating at least one laser beam parameter, and in a third step, designated by Block 64 the doped glass is locally irradiated by a continuous wave laser beam having the laser beam parameter(s), as further detailed hereinabove. Similarly to the respective steps in the previous methods, this method preferably comprises an optional, step, designated in FIG. 6 by block 66, in which the laser beam is focused by a suitable optical element. The third step and the optional focusing step are performed contemporaneously, and may be repeated a plurality of times, each time in a different location on the doped glass, so that a microlens array is formed.

The present invention is further of a microlens, a microlens array and an optical device incorporating the microlens array.

Thus, according to an additional another aspect of the present invention there is provided a microlens 24 formed in a doped glass 20 having at least one metallic component 22 other than copper.

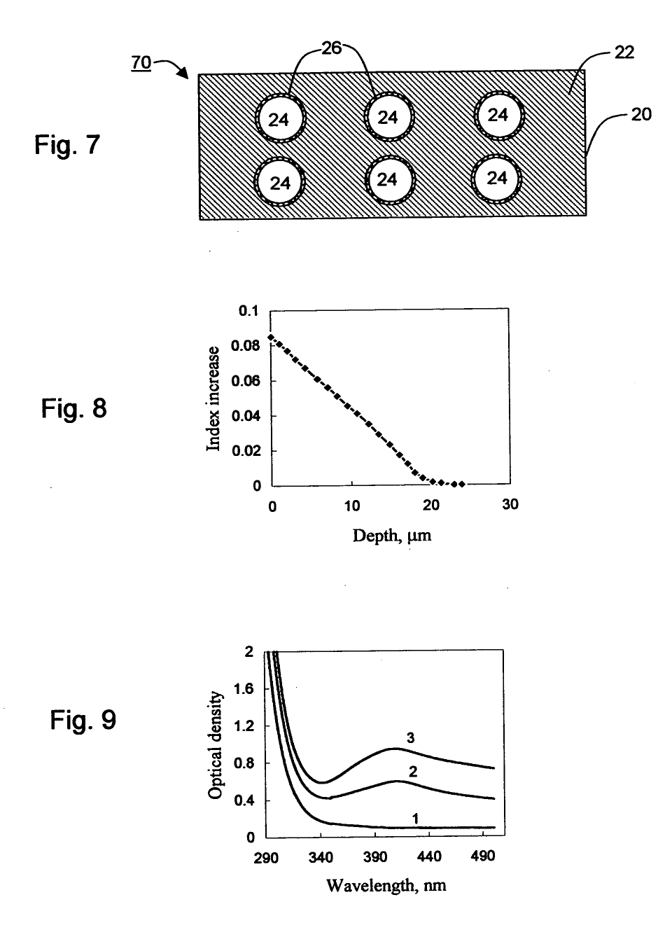

Referring to FIG. 7, according to still an additional another aspect of the present invention there is provided a microlens array 70, comprising a plurality of microlenses, e.g., microlens 24, formed in a doped glass 20 having at least one metallic component 22 other than copper, as further detailed hereinabove.

According to yet an additional aspect of the present invention there is provided a microlens 24 formed in a doped glass 20 having at least one metallic component 22 other than copper, the microlens being formed in doped glass by local radiation of a continuous wave laser beam, as further detailed hereinabove and exemplified in the Example section that follows.

According to yet still an additional another aspect of the present invention there is provided an optical device having at least one microlens array, e.g., microlens array 70. According to a preferred embodiment of the present invention the optical device can be any optical device in which the microlens array is incorporated, such as, but not limited to, an imaging device, a microscope, a confocal microscope, a telescope, a magnifying device, an optical interconnecting unit, a telecommunications device, a micro-optical device, an integrated optical circuit, a display device, a multi LCD projection device, a single LCD projection device, a LED based display device, an integral photography device, a retroreflector array, a surface characterization device, and a wavefront sensing device.

Following is a collection of preferred technical details, according to preferred embodiments of the present invention, which technical details are not to be considered as limiting.

Preferred dimensions of microlens 24 are from about 0.7 micrometer to about 100 micrometers in radius and from about 0.07 micrometer to about 10 micrometers in height.

A preferred spectrum of wavelengths to which microlens 24 is transparent is from about 350 nanometers to about 2 micrometers, more preferably from about 400 nanometers to about 2 micrometers.

A preferred intensity distribution of the laser beam is a central-symmetrical distribution, such as, but not limited to, a Gaussian. The intensity distribution is characterized by an effective radius which preferably selected in accordance with the desired size of the microlens. A typical effective radius, prior to impinging on the doped glass, in a micrometer scale.

The power range of the laser beam is preferably from about 10 to about 100 milliwatts and the preferred duration of laser radiation, for a formation of one microlens is from about 0.1 millisecond to about 10 seconds.

It is expected that during the life of this patent many relevant doped glasses will be developed and the scope of the term metal-doped glass is intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non limiting fashion.

### Example 1

### Microlens Formation

Experimental

Experiments were performed, in accordance with the teachings of present invention described above, on several glass samples with embedded silver (Ag) clusters of 20 nm diameter and average bulk density of 1.3·10¹⁶ cm³. The preparation of the glass/Ag composite consisted of two stages: (i) doping of the subsurface layer of the glass with Ag⁺ ions; and (ii) growing silver clusters within this layer in a Hydrogen atmosphere. The glass matrix was earlier developed for ion-exchange applications, and its composition is presented in Table 1, below.

TABLE 1

| Oxide | SiO₂ | Al₂O₃ | B₂O₃ | ZrO₂ | As₂O₃ | Na₂O | Li₂O |
|---|---|---|---|---|---|---|---|
| mol. % | 60.0 | 6.0 | 10.0 | 3.7 | 0.1 | 19.7 | 0.5 |

For the first stage, a conventional technique of ion exchange was used to exchange sodium ions of the glass with silver ions, in a mixture of 5 mol. % of AgNO₃ and 95 mol. % of NaNO₃ melts, at a working temperature of about 340° C.

The processing led to decreasing Na⁺ ion concentration and to increasing Ag⁺ concentration near the glass surface. Electron beam microanalysis technique was used to determine the concentration of silver ions at the surface of planar ion-exchanged samples. The maximal measured concentration of silver ions near the surface was about 13% by weight. The replacement of sodium ions with silver ions increases the refractive index and in fact a linear relationship exists between silver concentration and refractive index increase.

The ion exchange thus resulted in the formation of a planar optical waveguide, and waveguide mode spectroscopy was used to characterize the silver distributions within the processed samples. Sets of the effective indices of the waveguide modes were measured for processed samples by means of the standard prism-coupling technique. Those sets were used for calculating the refractive index of the exchanged regions of the doped glass as a function of the depth [J. M. White and P. F. Heidrich, Appl. Opt. 15:151(1976)].

FIG. 8 shows the inclement of the refractive index as a function of the depth, after 1 hour of ion exchange, where the depth is measured in μm. As shown in FIG. 8, the maximal thickness of the ion exchange region was about 20 μm.

In the second stage, the glass samples were annealed in a Hydrogen atmosphere at 180° C. for 1 hour, or 200° C. for 0.5 hour. The annealing process caused the initially colorless samples to become light brown near their surfaces.

FIG. 9 shows the optical density of three glass samples, designated 1, 2 and 3, after the annealing process. Glass sample 1 was not subjected to annealing process, glass sample 2 was subjected to 1 hour of annealing process at temperature of 180° and glass sample 3 was subjected to 0.5 hour of annealing process at temperature of 200°.

As shown in FIG. 9, the optical densities of the annealed glass samples have an absorption peak at 410 nm, corresponding to Ag nanoclusters. The absorption peak grows with annealing time and temperature, mainly due to growth of the cluster size.

After the preparation, the glass samples were irradiated by an Ar ion laser with wavelength, λ, of 488 nm. The beam power of the laser radiation varied from 30 to 60 mW. The beam was focused onto the glass surface through a 50×-microscope objective lens. During exposure of the samples to the laser radiation, the light intensity transmitted through the microlens being formed was monitored. After exposure, the microlens shape was analyzed using atomic force microscopy (AFM).

The intensity, I, of the laser beam had a Gaussian radial distribution
I(r,z)=Iₘ(z)exp[−2r²/w²(z)], (EQ. 4)
where the Iₘ(z) and w(z) represent, respectively, the maximum light intensity at the beam center, and the effective radius of the beam at depth z from the glass surface. The effective radius of the beam is given by,

$$w ( z ) = {{w}_{0} [ 1 + {( \frac{z}{{z}_{0}} )}^{2} ]}^{1 / 2} \qquad ( EQ . 5 )$$

where w₀ is a waist radius (w₀=0.7 μm in the present experiments), and z₀=πw₀²/λ is the confocal parameter [B. E. A. Saleh, M. C. Teich, “Fundamentals of Photonics”, Willey, New York, 1991].

As used herein, the z-axis is normal to the surface of the glass (with z=0 on the surface), and the x-y plane is parallel thereto.

Results

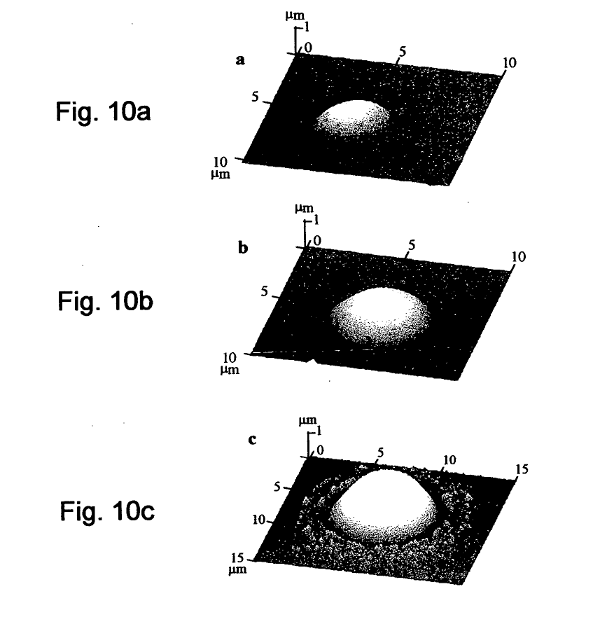

FIGS. 10a-c shows AFM images of the formed microlenses obtained at laser power of P=60 mW, for three different exposure times, 1 millisecond (FIG. 10a), 20 milliseconds (FIG. 10b) and 1000 milliseconds (FIG. 10c). As shown in FIGS. 10a-c the microlens radius and height increase with the time of exposure for a given P. FIG. 10c is a particular evidence for the above described motion of the Ag clusters from the lens axis to the periphery in the molten glass temperature gradient. As explained, due to this motion, Ag crystallites are formed on the surface surrounding the microlens.

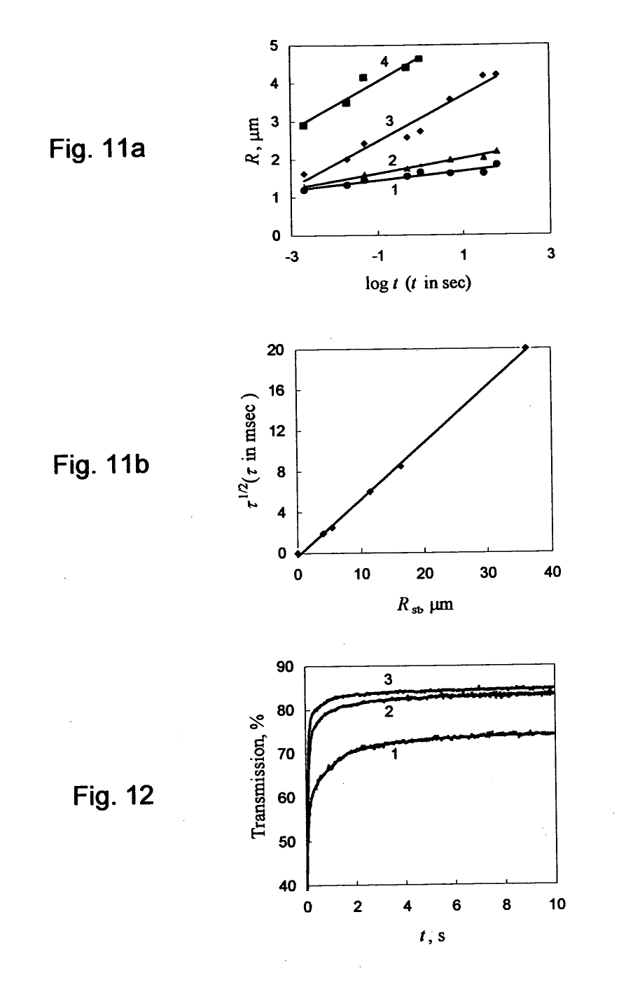

FIG. 11a is a plot of the microlens radius, R, measured in μm, as a function of the logarithm of time, t, where t is measured in seconds. Shown in FIG. 11a, four straight lines, designated 1-4, representing four different laser powers of P₁=37 mW, P₂=43 mW, P₃=54 mW and P₄=67 mW, respectively. Being a straight line on a semilogarithmic scale, the growth of R is exponential.

The measurements shown in FIG. 11a were in agreement with the following exponential expression:
R(t)=Rₛₜ(P)(1−e^{-t/r}). (EQ. 6)
where Rₛₜ(P) is the (P-dependent) stationary lens radius, to which R is approaching for large t, and τ is a characteristic time, which was found to be about 100-500 ms, depending on the laser power. The saturation of the growth of R for t>>τ implies that a steady state temperature distribution is formed around the illuminated spot.

Rₛₜ(P) is an increasing function of laser power, P, hence being also a function of the characteristic time τ. FIG. 11b is graph of the square root of τ, τ being measured in milliseconds, as a function of Rₛₜ. Shown in FIG. 11b is a straight line, which imply a quadratic relation between the characteristic time, τ, and the saturation radius, Rₛₜ:
τ∝Rₛₜ². (EQ. 7)

FIG. 12 shows the results of the measurements of light transmission through the irradiated area during the formation of the microlenses, for three laser powers: P=27.3, 33 and 40 mW. As shown the transparency rapidly increases during the formation of the microlens, and saturates after about 5 seconds of exposure. With low powers of laser radiation, the transmission reaches about 65%, whereas with higher powers the transmission reaches about 85%. As explained above, the increase of the lens transmission is caused both by the partial dissolution of the Ag clusters in the liquid drop and by the motion of the clusters from the lens axis to the periphery in the molten glass temperature gradient. Both the dissolution of the clusters and their radial motion are accelerated at higher laser power and thus lead to the increase of the lens transparency with power.

### Example 2

### Calculation of the Temperature Distribution

This Example is intended to exemplify the procedure of predicting the lens radius and height as functions of the laser power P, by calculating the temperature distribution around the “hot spot” inside the glass.

Analytical Calculation

A small volume of the glass, restricted by a “boundary” isotherm, Tₛ, which is higher than the glass transition temperature, is characterized during irradiation by a decreased viscous relaxation time (of the order of seconds). A circle of radius R at the glass surface corresponding to this isotherm defines the radius of the microlens. The height of the microlens, h, is determined from the depth of the liquid “drop”, H, and the temperature distribution in the z-direction.

For a laser intensity distribution, I(r,z), where r is the radial distance from the center of the beam, and α(z-dependent) absorption coefficient, α(z), of the doped glass, the steady state form of the diffusion equation (see Equation 1) is:
div[κ(T)·∇T]=−α(z)·I(r,z)/c (EQ. 8)

As stated, the non-linearity is removed by introducing the integrated function, θ, which has the following integral form (see also Equation 2).

$$θ = \frac{1}{{κ}_{0}} {\int }_{{T}_{0}}^{T} κ ( T ) ⅆ T \qquad ( EQ . 9 )$$

In terms of θ, Equation 8 can be written as:

$$Δ θ = \frac{- α ( z ) \cdot I ( r , z )}{{κ}_{0} c} \qquad ( EQ . 10 )$$

The boundary conditions for T and θ are:

$$\begin{matrix}\frac{\partial T}{\partial z} {\vert}_{z = 0} = \frac{\partial θ}{\partial z} {\vert}_{z = 0} = 0 & ( EQ . 11 ) \\ T {\vert}_{r \to ∞} = {T}_{0} , θ {\vert}_{r \to ∞} = θ ( {T}_{0} ) = {θ}_{0} & ( EQ . 12 )\end{matrix}$$

The physical interpretation of Equation 11 is that heat flux to air is neglected. The absorption coefficient, α(z), which appears in Equations 8 and 10, was approximated by the following expression, known to describe the concentration distribution during diffusion into a thin layer:
α(z)=α₀exp(−z²/l²) (EQ. 13)
where l has the physical meaning of an effective diffusion depth 2(Dt)^{1/2}, with D being the diffusion coefficient, and t being the diffusion time, and α₀ is the absorption coefficient at the surface the glass (z=0).

The dimensionless product α₀l is related to optical transmission through the expression:

$$Transmission = exp ( - {\int }_{0}^{∞} α ( z ) ⅆ z ) = exp ( - \frac{\sqrt{π} \cdot {α}_{0} l}{2} ) \qquad ( EQ . 14 )$$

hence, can be measured optically.

Introducing dimensionless variables: Z=α₀z, r=\sqrt{x²+y²}/w₀ one can present the solution of Equation 10 in the integral form:

$$θ ( r , Z ) = \frac{P}{2 πκ c {w}_{0}} {\int }_{0}^{∞} \frac{A ( u ) \cdot α ( u )}{ϕ ( u )} ⅆ u \times {\int }_{0}^{∞} {I}_{0} ( \frac{4 ρ r}{ϕ ( u )} ) \cdot ( \frac{1}{{M}_{+}} + \frac{1}{{M}_{-}} ) \cdot exp [ - 2 \frac{( {ρ}^{2} + {r}^{2} )}{ϕ ( u )} ] \cdot ρ ⅆ ρ \qquad ( EQ . 15 )$$

where,

$${M}_{\pm } = \sqrt{{ρ}^{2} + {( \frac{z \pm u}{{w}_{0}} )}^{2}} ,$$

I₀ is the modified Bessel function of zero order,

$$ϕ ( u ) = 1 + {( \frac{u}{{z}_{0}} )}^{2} ,$$

and

$$A ( u ) = exp ( - {\int }_{0}^{u} α ( z ) ⅆ z ) = exp [ - \frac{{α}_{0} l \sqrt{π}}{2} erf ( \frac{u}{{α}_{0} l} ) ] .$$

It is known [J. E. Parrott and A. D. Stuckes, “Thermal Conductivity of Solids”, Pion Limited, London, 1975] that heat diffusivity of the glass, κ, grows exponentially with temperature. Thus, the following empirical temperature dependence of κ(T) is used:
κ(T)=Ce^{γT} (EQ. 16)
with C=0.95·10⁻² W·cm⁻¹·K⁻¹ and γ=6.7·10⁻⁴ K⁻¹.

Substituting Equation 16 into Equation 9 one finds the temperature distribution:
T(r,Z)≈T₀+θ(r,Z). (EQ. 17)
With θ taken from Equation 15.

Effect of the Diffusion Layer

As further demonstrated below, the above calculations show that the temperature distribution, T(r,Z), depends noticeably on the thickness and absorption characteristics of the diffusion layer filled by Ag nanoclusters.

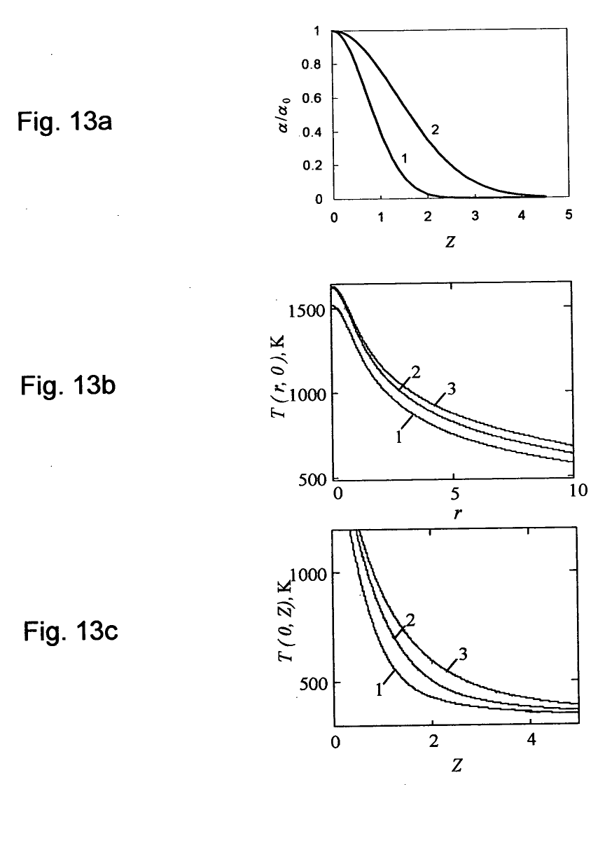

Hence, FIG. 13a shows two curves of α(z)/α₀, designated 1 and 2. The curves were calculated using Equation 13 for two values of the diffusion depth, l₁=11.6 μm and l₂=21.7 μm, respectively. The choice of these particular values of diffusion depth will be explained hereinafter.

FIGS. 13b-c, shows plots of the temperature distribution at z=0 (FIG. 13b) and at r=0 (FIG. 13c), calculated using Equation 15. Each of FIGS. 13b-c shows three curves, designated 1-3, for three different values of the dimensionless product, α₀l=1.04 (designated 1), α₀l=1.35 (designated 2) and α₀l=1.95 (designated 3). Two of these values (1.04 and 1.95) were determined from transmission measurements of the glass samples of Example 1.

The value of 1.04 was determined for the glass sample which was annealed for 1 h at a temperature of 180° C., and value of 1.95 was determined for the glass sample which was for 0.5 h at a temperature of 200° C. (see FIG. 9 in Example 1, above).

Also shown are the temperature distributions calculated for homogeneous absorption medium (α=α₀=900 cm⁻¹).

As shown in FIGS. 13b-c, the thinner the diffusion layer the lower is the temperature at a given radial distance, r, and at a given depth, Z, along the beam axis. It is thus demonstrated that the effect of the temperature distribution on the diffusion layer is more critical when the diffusion depth, l, is small compared to α₀⁻¹.

In previous experiments with Cu-doped glass [Kaganovskii et. al., J. Appl. Phys., ibid] the effect of the structure of the diffusion layer was not observed, since the value α₀⁻¹ was about two times smaller whereas the diffusion depth l was several times longer than for Ag-doped glass.

Comparison with Experiments

As stated, the microlens shape and size can be defined from isotherms of the temperature distribution. In this Example, the microlens radius, R, is determined by a surface isotherm Tₛ, corresponding to a temperature of 900 K, at which relaxation time of the glass is of order of seconds. For calculations the following numbers were used κ₀=3·10⁻⁷ m²/s and c=3.8·10⁶ J/m³K.

Since optical measurement can only determine the dimensionless product α₀l as opposed to separate determinations of α₀ and l. The comparison of theory and the experimental results presented in Example 1, is based on extracting the diffusion depth by matching measured points to their corresponding calculated curves, as further explained in the following.

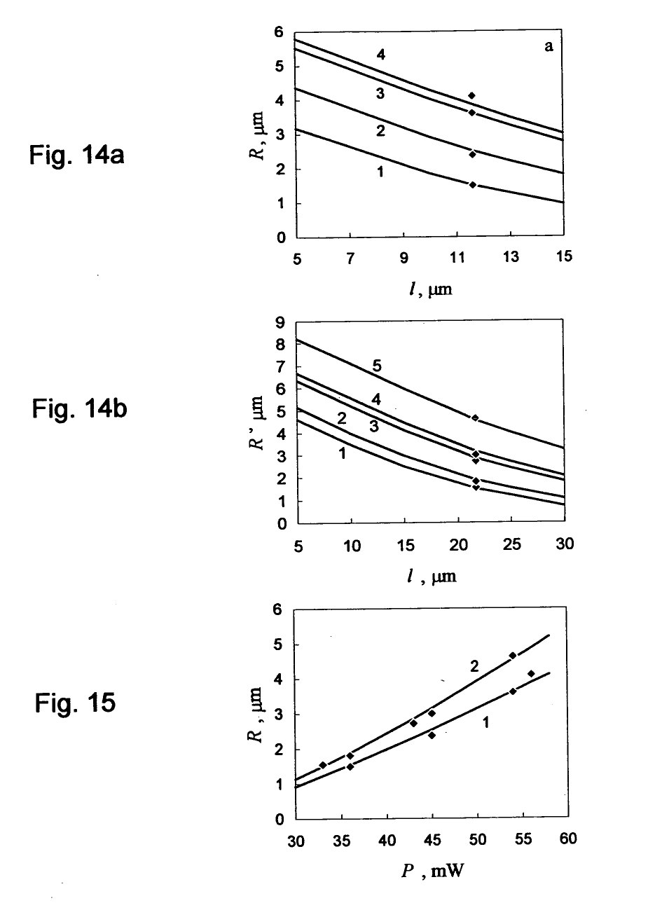

Hence, FIG. 14a-b show calculations of the microlens radius, R, calculated as a function of the diffusion depth l, for α₀l=1.04 (FIG. 14a) and α₀l=1.95 (FIG. 14b). FIG. 14a shows four curves for P=36, 45, 54 and 56 mW, and FIG. 14b shows five curves for P=33, 36, 43, 45 and 54 mW. Also shown in FIGS. 14a-b are respective experimental points for each value of the laser power measured at a particular diffusion depth, which is to be determined from the plots.

Thus, referring to FIG. 14a, the measurements in the glass sample in which α₀l=1.04 (1 h of annealing at a temperature of 180° C.) are consistent with a diffusion depth of l₁=11.6 μm, and referring to FIG. 14b, the measurements in the glass sample in which α₀l=1.95 (0.5 h of annealing at a temperature of 200° C.) are consistent with a diffusion depth of l₂=21.7 μm. The ratio of these values of diffusion length is consistent with the ratio of the two corresponding dimensionless products α₀l, implying that from both measurements the same value of α₀=900 cm⁻¹ was obtained. These values of the diffusion lengths are consistent with the measurements of the refractive index (see FIG. 8 in Example 1, above).

FIG. 15 shows calculations and experimental results of the microlens radius, R, as a function of the laser power P, using the above determined values of the diffusion lengths and α₀. As can be seen there is an excellent agreement between the theoretical calculations and the experimental points.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1-221. (canceled)

222. A method of forming a microlens, comprising providing a doped glass having at least one metallic component other than copper, and locally irradiating said doped glass by a continuous wave laser beam, so as to melt a portion of said doped glass, thereby to form the microlens.

223. The method of claim 222, wherein said at least one metallic component is selected from the group consisting of silver, gold, nickel, ferrum, cerium, and platinum.

224. The method of claim 222, wherein said at least one metallic component forms at least one diffusion layer of metallic nanoclusters.

225. The method of claim 222, wherein said at least one metallic component forms a bulk in said doped glass.

226. The method of claim 224, wherein a diffusion depth of said at least one diffusion layer is from about 3 micrometers to about 100 micrometers.

227. The method of claim 222, wherein said doped glass is characterized by a predetermined optical absorption spectrum.

228. The method of claim 222, wherein at least one of an exposure duration, a power, an impinging angle, a polarization, a divergence and an intensity distribution of said irradiation is selected so as to provide the microlens with at least one predetermined characteristic selected from the group consisting of radius, height, prismatic properties and focal length.

229. The method of claim 228, wherein said radius of the microlens is from about 0.7 micrometer to about 100 micrometers.

230. The method of claim 228, wherein said height of the microlens is from about 0.07 micrometer to about 10 micrometers.

231. The method of claim 222, wherein at least one of an exposure duration, a power, an impinging angle, a polarization, a divergence and an intensity distribution of said irradiation is selected such that the microlens is transparent to light having a wavelength from about 350 nanometers to about 2 micrometers.

232. The method of claim 222, wherein at least one of an exposure duration, a power, an impinging angle, a polarization, a divergence and an intensity distribution of said irradiation is selected so that the microlens is transparent to visible light.

233. The method of claim 222, wherein at least one of an exposure duration, a power, an impinging angle, a polarization, a divergence and an intensity distribution of said irradiation is selected so that the microlens is transparent to infrared light.

234. The method of claim 227, wherein said predetermined optical absorption spectrum is such that said doped glass absorbs laser radiation having sufficiently small wavelength.

235. The method of claim 222, further comprising focusing said laser beam.

236. The method of claim 235, wherein said focusing is by an optical element selected from the group consisting of a microscope objective lens, a GRIN lens and a diffraction lens.

237. The method of claim 235, wherein said focusing is performed so as to control at least one of a shape and size, a transparency and prismatic properties of the microlens.

238. The method of claim 222, wherein an effective radius of said laser beam, prior to impinging on said doped glass, is in a micrometer scale.

239. The method of claim 222, wherein a duration of said irradiation is from about 0.1 millisecond to about 10 seconds.

240. A method of forming a microlens array, comprising:
(a) providing a doped glass having at least one metallic component other than copper;
(b) selecting a plurality of locations on said doped glass; and
(c) at each location of said plurality of locations, irradiating said doped glass by a continuous wave laser beam, so as to melt a portion of said doped glass, thereby to form a microlens at said location;
thereby forming a microlens array.

241. A microlens formed in a doped glass having at least one metallic component other than copper, the microlens being formed in said doped glass by local radiation of a continuous wave laser beam, selected so as to melt a portion of said doped glass, thereby to form the microlens.

242. The microlens of claim 241, wherein said at least one metallic component forms a plurality of crystallites surrounding the microlens.

243. A microlens formed in a doped glass having at least one metallic component other than copper, the microlens is transparent to light having a wavelength from about 350 nanometers to about 2 micrometers.

244. A microlens array, comprising a plurality of microlenses formed in a doped glass having at least one metallic component other than copper, wherein each of said plurality of microlenses of the microlens array is transparent to light having a wavelength from about 350 nanometers to about 2 micrometers.

245. The microlens array of claim 244, wherein said at least one metallic component forms a plurality of crystallites surrounding at least a portion of said plurality of microlenses.

246. An optical device having at least one microlens array, the microlens array comprising a plurality of microlenses formed in a doped glass having at least one metallic component other than copper, wherein each of said plurality of microlenses of the microlens array is transparent to light having a wavelength from about 350 nanometers to about 2 micrometers.

247. The optical device of claim 246, selected from the group consisting of an imaging device, a microscope, a confocal microscope, a telescope, a magnifying device, an optical interconnecting unit, a telecommunications device, a micro-optical device, an integrated optical circuit, a display device, a multi LCD projection device, a single LCD projection device, a LED based display device, an integral photography device, a retroreflector array, a surface characterization device, and a wavefront sensing device.

248. A method of forming a microlens, comprising:
(a) doping a glass with at least one metallic component other than copper, thereby providing a doped glass; and
(b) locally irradiating said doped glass by a continuous wave laser beam, so as to melt a portion of said doped glass, thereby to form the microlens.

249. The method of claim 248, wherein said doping said glass with said at least one metallic component comprises:
(i) exchanging ions of said glass with ions of said at least one metallic component; and
(ii) generating conditions for growth of metallic nanoclusters of said at least one metallic component, thereby providing at least one diffusion layer of metallic nanoclusters.

250. The method of claim 248, wherein said doping said glass with said at least one metallic component comprises:
(i) providing a molten environment and mixing said at least one metallic component therein, so as to provide a mixed molten environment; and
(ii) cooling said mixed molten environment so as to form a glass having a bulk of said at least one metallic component doped therein.

251. The method of claim 250, wherein said glass melt comprises at least one component selected from the group consisting of powdered silica, sodium carbonate, lithium carbonate, boron oxide, zirconium oxide, cerium oxide, aluminum oxide and arsenic oxide.

252. The method of claim 249, wherein said ions of said glass are alkali ions.

253. The method of claim 249, wherein said ions of said glass are selected from the group consisting of sodium ions, lithium ions, rubidium ions, cesium ions and potassium ions.

254. The method of claim 249, wherein said exchanging ions of said glass with ions of said at least one metallic component is by positioning said glass in a molted environment comprising a mix alkaline and the at least one metallic component.

255. The method of claim 254, wherein said molted environment comprising at least one combination selected from the group consisting of AgNO₃, AgNO₃ and NaNO₃, AgNO₃ and KNO₃, AgNO₃ and (NaNO₃+KNO₃).

256. The method of claim 249, further comprising exchanging ions of said glass with ions present in a molted salt containing alkaline ions.

257. The method of claim 254, wherein said molted environment comprises about 5 parts of said AgNO₃ and about 95 parts of said NaNO₃.

258. The method of claim 248, wherein said doping said glass is done so as that a concentration of said at least one metallic component within a predetermined region of said doped glass is at least 5 percent by weight.

259. The method of claim 249, wherein said generating said conditions for said growth of said metallic nanoclusters is by annealing said doped glass in Hydrogen atmosphere.

260. The method of claim 248, wherein said doping said glass is characterized by a dopant type, a dopant concentration level, a doping time and a doping temperature, and further wherein at least one of said dopant type, said dopant concentration level, said doping time and said doping temperature is selected so as to provide said doped glass with a predetermined optical absorption spectrum.

261. A method of forming at least one microlens on a doped glass having at least one metallic component other than copper, the method comprising:
(a) selecting a shape and size for the microlens;
(b) using physical characteristics of the doped glass for calculating at least one laser beam parameter, said at least one laser beam parameter being suitable for providing said shape and size of the at least one microlens; and
(c) locally irradiating the doped glass by a continuous wave laser beam having said at least one laser beam parameter, so as to melt a portion of the doped glass, thereby to form the at least one microlens.

262. The method of claim 261, further comprising repeating said step (c) a plurality of times, each time in a different location on the doped glass, to form a microlens array.

263. The method of claim 261, wherein said calculating said at least one laser beam parameter comprises calculating a temperature distribution of the doped glass and using said temperature distribution for calculating said at least one laser beam parameter.

264. The method of claim 263, wherein said calculating said temperature distribution comprises solving a heat diffusion equation.

265. The method of claim 264, wherein said heat diffusion equation is a non-linear heat diffusion equation, being characterized by a non-linear term.

266. The method of claim 265, wherein said non-linear term comprises a temperature dependent thermal diffusivity.

267. The method of claim 266, further comprising performing a linearization procedure on said non-linear heat diffusion equation, thereby constructing a linear differential equation.

268. The method of claim 263, wherein said calculating said at least one laser beam parameter comprises generating a graphical representation of said temperature distribution, and detecting portions of said graphical representation corresponding to a formation of the at least one microlens.

269. The method of claim 268, wherein said graphical representation comprises a plurality of isotherms.

270. The method of claim 269, wherein said portions of said graphical representation comprises at least one isotherm of said plurality of isotherms.

271. A method of forming at least one microlens having a predetermined shape and size, comprising:
(a) doping a glass with at least one metallic component other than copper, thereby providing a doped glass;
(b) using physical characteristics of said doped glass for calculating at least one laser beam parameter, said at least one laser beam parameter being suitable for providing the predetermined shape and size of the at least one microlens; and
(c) locally irradiating said doped glass by a continuous wave laser beam having said at least one laser beam parameter, so as to melt a portion of the doped glass, thereby to form the at least one microlens.
